(19) United States
(12) Patent Application Publication
(10) Pub. No.: US 2018/0009289 A1
(43) Pub. Date: Jan. 11, 2018

(54) CLIMATE CONTROL METHOD AND SYSTEM

(71) Applicant: FORD GLOBAL TECHNOLOGIES, LLC, Dearborn, MI (US)

(72) Inventors: Jonathan Max Grossman, London (GB); Saidat Osarhenomase Giwa-Osagie, Barking (GB)

(21) Appl. No.: 15/640,939

(22) Filed: Jul. 3, 2017

(30) Foreign Application Priority Data
Jul. 6, 2016 (GB) 1611755.8

(51) Int. Cl. B60H 1/00; B60H 1/32; F24F 11/00

(52) U.S. Cl. CPC B60H 1/00742; B60H 1/00785; B60H 1/00792; B60H 1/00885; B60H 1/00771; F24F 2011/0036; F24F 2011/0057; F24F 2011/0068; B60H 2001/3244

(57) ABSTRACT

A climate control method for a vehicle including the steps of determining a moisture level of an occupant of the vehicle; and adjusting a climate control system of the vehicle depending on the moisture level of the occupant.

### TECHNICAL FIELD

This disclosure relates to the control of a climate control system for a vehicle based on a determined moisture level of an occupant of the vehicle.

### BACKGROUND

A modern vehicle can be fitted with a climate control system that can be used to condition the environment internal to the vehicle. For example, the climate control system may comprise a heating, ventilation and air conditioning (HVAC) system configured to adjust the conditions within the vehicle to a desired level.

In order to help more precisely control the conditions within the vehicle, the climate control system may comprise one or more temperature sensors that can determine the temperature within the vehicle. In this manner, the climate control system has a control feedback loop that can be used to adjust the operation of the HVAC system depending on the measured temperature.

However, temperature measurements alone may not provide adequate data regarding the physical state of the occupant, which can lead to suboptimal comfort levels within the vehicle. It is desirable, therefore, to adjust the climate control system depending on the physical condition of the occupant, and indeed the manner in which the occupant responds to the operational parameters of the HVAC system.

### SUMMARY

According to an aspect of the present disclosure there is provided a climate control method for a vehicle, the method comprising: determining a moisture level of an occupant of the vehicle; determining a rate of change of the moisture level of the occupant; and adjusting a climate control system of the vehicle depending on the rate of change of the moisture level of the occupant.

The method may comprise determining a temperature level of the occupant of the vehicle. The method may comprise comparing the moisture level to the temperature level to determine a physical condition of the occupant. The method may comprise adjusting the climate control system of the vehicle depending on the physical condition of the occupant.

The method may comprise determining a temperature of the environment external to the vehicle. The method may comprise comparing the temperature of the environment external to the vehicle to the moisture level of the occupant. The method may comprise adjusting the climate control system of the vehicle depending on the comparison between the temperature of the environment external to the vehicle and the moisture level of the occupant.

The method may comprise determining a future geographical location of the vehicle, for example using a global positioning system of the vehicle. The vehicle may be a connected vehicle that is able to share data using a local wireless area network or cellular data. The method may comprise determining the temperature of the environment external to the vehicle at the future geographical location, for example by comparing the intended route of the vehicle with weather data retrieved from a remote server. The method may comprise adjusting a climate control system of the vehicle depending on the temperature of the environment external to the vehicle at the future geographical location.

The method may comprise determining a first moisture level of the occupant during a first journey. The method may comprise determining a second moisture level of the occupant during a second journey. The method may comprise creating an occupant profile based on the determined moisture levels. The method may comprise adjusting the climate control system of the vehicle depending on the occupant profile. In this manner, the climate control system may be able to adjust automatically the operation of the climate control system depending on the type of journey that is undertaken by the occupant.

The method may comprise predicting a journey of the vehicle, for example using a navigation system of the vehicle. The method may comprise adjusting automatically the climate control system based on the predicted journey of the vehicle.

The method may comprise determining remotely the moisture level of the occupant. For example, the moisture sensor may comprise an imaging device positioned at one or more appropriate locations within the vehicle. The method may comprise determining the moisture level of the occupant's skin. For example, the method may comprise determining the moisture level of the face, an arm, a leg, and/or any other appropriate body portion.

The method may comprise determining the position of the occupant within the vehicle. The method may comprise automatically positioning one or more portion, for example a vent, of the climate control system depending on the position of the occupant. In this manner, the climate control system is able to redirect airflow to an area of the occupant that requires heating or cooling.

According to another aspect of the present disclosure there is provided a climate control method comprising: determining a future geographical location of a vehicle; determining the temperature of the environment at the future geographical location; and adjusting a climate control system of the vehicle depending on the temperature of the environment at the future geographical location.

According to another aspect of the present disclosure there is provided a climate control system for a vehicle, the climate control system comprising: a moisture sensor configured to determine a moisture level of an occupant of the vehicle.

A vehicle may be provided comprising one or more of the above mentioned climate control systems.

The present disclosure is advantageous as it provides for the automatic control of the climate control system of the vehicle. The climate control method and/or the climate control system described herein allows for the removal of one or more driver distractions, by automatically controlling the climate internal to the vehicle in response to one or more of the above described parameters, such as the moisture level of the occupant and/or the temperature level of the occupant. For example, a vehicle fitted with the climate control system removes the need for a driver and/or a passenger of the vehicle to operate a control of the climate control system, which reduces the chances of the driver of the vehicle becoming distracted whist operating the vehicle.

The disclosure also provides software, such as a computer program or a computer program product for carrying out any of the methods described herein, and a computer readable medium having stored thereon a program for carrying out any of the methods described herein. A computer program embodying the disclosure may be stored on a computer-readable medium, or it could, for example, be in the form of a signal such as a downloadable data signal provided from an Internet website, or it could be in any other form.

To avoid unnecessary duplication of effort and repetition of text in the specification, certain features are described in relation to only one or several aspects or arrangements of the disclosure. However, it is to be understood that, where it is technically possible, features described in relation to any aspect or arrangement of the disclosure may also be used with any other aspect or arrangement of the disclosure

### BRIEF DESCRIPTION OF THE DRAWING FIGURES

For a better understanding of the present disclosure, and to show more clearly how it may be carried into effect, reference will now be made, by way of example, to the accompanying drawings, in which:

FIG. 1 depicts a method of climate control.

FIG. 2 depicts a climate control system.

### DETAILED DESCRIPTION

The present disclosure provides a method 100 of controlling a climate control system, for example a climate control system of a vehicle. The vehicle may be any type of vehicle, such a car, a van, a truck, a marine vessel or an aircraft. In another arrangement, however, the climate control system may be configured for use in a building, and/or in any environment where it is desirable to control the climate surrounding an individual.

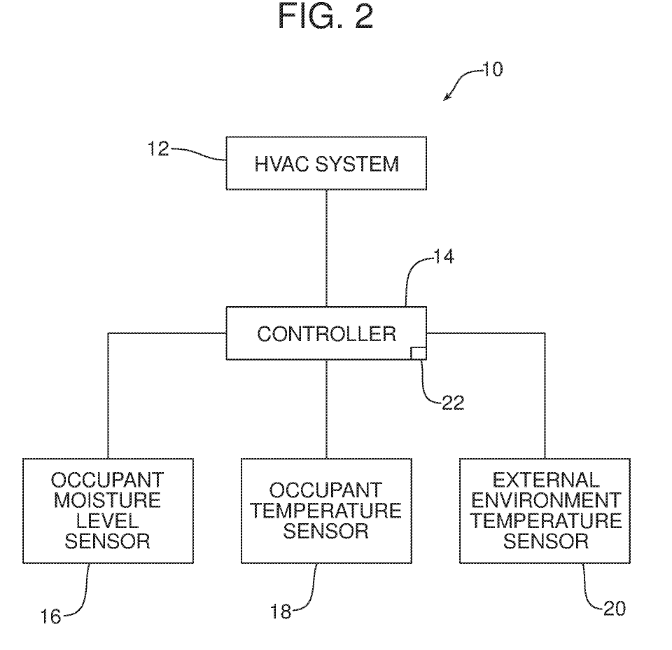

As depicted in FIG. 2, the climate control system 10 includes at least a portion of a heating, ventilation and air conditioning system 12 and a configurable controller 14 for controlling the heating ventilating and air conditioning system of the climate control system. In the illustrated embodiment, the controller 14 is connected to an occupant moisture sensor 16, an occupant temperature sensor 18 and an external environment temperature sensor 20.

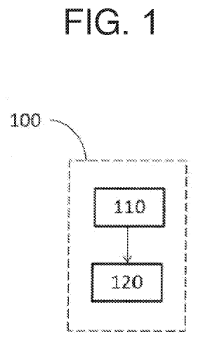

FIG. 1 depicts the method 100 of controlling the climate control system 10 of a vehicle. As noted above, the climate control system 10 may comprise at least a portion of a heating, ventilation and air conditioning (HVAC) system 12 of the vehicle, such that the control method 100 can be used to control, for example adjust, the operation of the HVAC system. For example, the HVAC system 12 may comprise one or more blowers configured to direct an airflow towards a particular position within the vehicle. Additionally or alternatively, the climate control system 10 may comprise an air conditioning unit configured to control the temperature and/or humidity of the environment within the vehicle. In this manner, the climate control system 10 may be configured to control at least one operational parameter of the HVAC system 12.

It is known to use a temperature sensor and/or a humidity sensor to determine the conditions within the vehicle. The determined data from the sensor may be used to control the operation of the HVAC system. For example, where an occupant of the vehicle sets a desired parameter, such as the temperature of the cabin, the determined data may be used in a feedback loop to adjust the operation of the HVAC if the conditions within the vehicle are different from those requested by the occupant.

One problem, however, is that the data derived from the sensors may not reflect the actual physical condition of the occupant. For example, a climate control system 10 having one or more vehicle temperature sensors may actually be configured to control the temperature of the environment within the vehicle, and not the physical temperature of the occupant. It is desirable, therefore, to provide the climate control system 10 with one or more sensors that are able to determine the physical condition of the occupant, so that one or more operational parameters of the HVAC system can be adjusted accordingly.

The climate control system 10 according to the present disclosure comprises at least one moisture sensor configured to determine the moisture level of the occupant of the vehicle. The moisture sensor 16 may be particularly useful in determining if the occupant of the vehicle is sweating, for example. The moisture sensor 16 may comprise one or more electrodes configured to determine the moisture level of a portion of the occupant's skin. For example, the moisture sensor 16 may be configured to extend from a portion of the vehicle and engage a portion of the occupant's skin. The moisture sensor 16 may be configured to be integrated into an article of vehicle furniture, such as a headrest of a vehicle seat, and/or into one or more of the controls of the vehicle, such as a steering wheel.

Additionally or alternatively, the moisture sensor 16 may comprise a non-contact moisture sensor configured to determine a moisture level of the occupant. For example, the moisture sensor may comprise an imaging device configured to capture an image of the occupant. The imaging device may be configured to image a face of the occupant so that the moisture sensor can determine the level of moisture of the occupant's facial skin. The imaging device may, however, be configured to image any appropriate portion of the occupant, for example an arm and/or a leg of the occupant. The imaging device may be configured to analyse the condition of the occupant's skin by virtue of at least one kind of light. For example, the imaging device may be configured to perform analysis using visible, ultraviolet and/or infrared light. Additionally or alternatively, the imaging device may be configured to determine the shine, or level of reflectiveness, of the occupant's skin. A determination may be made as to the condition of the occupant's skin based upon the level of reflectiveness. For example, where an occupant has sweat on their skin, the reflectiveness of the skin may be higher than a region that does not have sweat on it.

In one arrangement, the imaging device may comprise a plurality of sensors provided within the interior of the vehicle. For example, a first sensor may be provided in the dashboard of a vehicle so that it is able to image the face of the occupant, and a second sensor may be provided in a door panel of the vehicle so that it is able to image an arm of the occupant. In this manner, the plurality of sensors may be configured to determine data regarding the overall moisture condition of the occupant.

The disclosure will now be described by way of the below example where the occupant has been performing exercise prior to entering the vehicle. In such a circumstance, the occupant may be sweaty upon entering the vehicle. However, depending on the conditions of the environment external to the vehicle, the temperature of the occupant's skin may vary. For example, where the occupant has been exercising in a warm climate, the skin on the occupant's forehead may be sweaty and warm. In contrast, where the occupant has been exercising in a cool climate, the skin on the occupant's forehead may be sweaty and cool. It is desirable, therefore, for the climate control system 10 of the vehicle to adjust the settings of the HVAC system 12 according to a physical condition of the occupant. For example, where the occupant's skin is warm and sweaty, the occupant may desire the HVAC system 12 to cool and dehumidify the environment internal to the vehicle. In contrast where the occupant's skin is cool and sweaty, the occupant may desire the HVAC system 12 to warm and dehumidify the environment internal to the vehicle. The present disclosure is advantageous, therefore, as it is able to determine the moisture level of the occupant of the vehicle and adjust the climate control system 10 of the vehicle accordingly.

The method 100 comprises a step 110 of determining a moisture level of an occupant of the vehicle by the occupant moisture level sensor 16 and may comprise an additional step of determining the temperature level of the occupant by the occupant temperature sensor 18. The controller 14 of the climate control system 10 may be configured to compare the moisture level of the occupant to the temperature level of the occupant in order to derive an understanding of the physical condition of the occupant. Consequently, the climate control system 10 may be adjusted by the controller 14 depending on the true physical condition of the occupant, which is advantageous as it gives an increased understanding of the needs of the occupant than is possible if the temperature data and moisture data are used independently from each another.

In another arrangement, the climate control system 10 may be configured to determine the temperature of the environment external to the vehicle by the external environment temperature sensor 20. In this manner, the controller 14 of the climate control system 10 is able to compare a moisture level of the occupant to the temperature of the environment external to the vehicle, in order to gain an understanding of how the occupant is reacting to the environment external to the vehicle. The method 100 may comprise the step 120 of adjusting by the controller 14 the climate control system 10 depending on the comparison between the temperature outside of the vehicle and the moisture level of the occupant's skin. For example, where the temperature outside the vehicle is warm, the occupant may have a build-up of moisture on their skin. As such, the occupant may desire a first mode of control of the climate control system 10, for example a higher rate of cooling of the skin in combination with a high rate of the humidification of the environment internal to the vehicle.

In another example, the temperature outside the vehicle may be cool and it may be raining. The occupant's skin may therefore be cool and moist, and as such the occupant may desire a second mode of control of the climate control system 10. For example, where the occupant is cool and moist the occupant may desire that the climate control system 10 both dehumidifies the environment internal to the vehicle and warms the skin.

In another arrangement, the climate control system 10 may be configured to determine the geographical location of the vehicle, for example by virtue of a global positioning satellite (GPS) system 22 of the vehicle. Additionally or alternatively, a control system 10 may be configured to determine a future geographical location of the vehicle, based upon data regarding the intended route of the vehicle, which may be obtained from the GPS system 22 of the vehicle. Where the vehicle is a connected vehicle, the controller 14 of the climate control system 10 may be configured to operatively connect via a wireless local area network to a remote server in order to determine the weather conditions at a future location of the vehicle. In this manner, the climate control system 10 may be configured to adjust the settings of the climate control system based upon data regarding the weather conditions at the future location of the vehicle. In the present disclosure, the term connected vehicle is understood to mean a vehicle that is configured to connect to other devices both inside as well as outside the vehicle via a wireless connection.

In another arrangement, the controller 14 of the climate control system 10 may be configured to determine the rate of change of the moisture level of the occupant. This may be advantageous as a first occupant of the vehicle may react in a different manner to a second occupant of the vehicle for a given setting of the climate control system 10. The controller 14 of the climate control system 10 may be configured to determine the changing moisture levels of each individual occupant of the vehicle, and to adjust accordingly the climate control zone of the vehicle. For example, the rate of change of a skin moisture level of the first occupant may be different to the rate of change of the skin moisture level of the second occupant. As such, the controller 14 of the climate control system 10 may be configured to adjust the humidity levels of respective zones of the environment internal to the vehicle. In this manner, the rate of change of environmental conditions internal to the vehicle may be adjusted depending on the determined rate of change of the moisture level of the first occupant's skin and/or the second occupant's skin.

In another arrangement, the climate control system 10 may be configured to determine a first moisture level, or a first moisture profile incorporating the rate of change of moisture, of the occupant during a first journey of the vehicle. The first journey may be a usual journey of the occupant, for example a trip from home to the workplace of the occupant at a particular time of day. Additionally, the climate control system 10 may be configured to determine a second moisture level, or a second moisture profile incorporating the rate of change of moisture, of the occupant during a second journey of the vehicle. The second journey may be another usual journey of the occupant, for example a trip from the home to the residence of a friend or family member. The climate control system 10 may, therefore, be configured to build an occupant profile based on the determined moisture levels for each of the first and second journeys. In this manner, the climate control system 10 may be adjusted depending on the occupant profile and the intended journey of the occupant. For example, the climate control system 10 may be configured to apply a first rate of cooling and dehumidification when it is determined that the occupant is on the first journey, and a second rate of cooling and dehumidification when it is determined that the occupant is on the second journey. The present disclosure therefore provides a predictive climate control system 10 that is able to automatically adapt the settings of the climate control system depending on the moisture profiles, which have been derived from the occupant over a plurality of journeys for example.

The climate control system 10 may be configured to determine a moisture profile of a first occupant, for example a moisture profile of the driver of the vehicle, and a moisture profile of at least one other occupant, for example a moisture profile of one or more passengers, of the vehicle. The climate control system 10 may be configured to record and store data relating to one or more occupant profiles over a plurality of journeys. In this manner, the climate control system 10 may be configured to control one or more climate zones of the environment internal of the vehicle depending on the moisture profile of the driver of the vehicle and/or the moisture profile of one or more passengers. For example, if a driver of the vehicle periodically collects a known passenger from a certain location and/or at a certain time of day, the climate control system 10 is able to adjust the climate of the passenger's climate zone depending on the determined moisture profile of the said passenger independently from the climate of the driver's climate zone.

The moisture profile of the occupant of the vehicle, for example the moisture profile of the driver or the passenger, may be determined based upon a calendar. For example, the climate control system 10 may comprise a controller 14 that is operatively connected to one or more personal computing devices of the occupant, such as a smart phone or a laptop. In this manner, the controller 14 can adjust the climate internal to the vehicle depending on the occupant's calendar or schedule, which may be stored on the occupant's personal computing device. For example, if the controller 14 determines that the occupant has a gym session scheduled in their calendar, the climate control system 10 may be configured to adjust one or more climate zones of the vehicle when the occupant enters the vehicle following their gym session, i.e. depending on the occupant's scheduled activity. Additionally or alternatively, the climate control system 10 may be configured to determine the moisture profile of the occupant based upon the time of the day and/or the year. In this manner, the climate control system 10 may be configured to automatically adjust one or more climate zones of the vehicle depending on the occupant profile, which may be a function of the time of the day and/or the time of the year at which the occupant uses the vehicle.

It will be appreciated by those skilled in the art that although the disclosure has been described by way of example with reference to one or more arrangements, it is not limited to the disclosed arrangements and that alternative arrangements could be constructed without departing from the scope of the disclosure as defined by the appended claims.

What is claimed:

1. A climate control method for a vehicle, the method comprising:
determining a moisture level of an occupant of the vehicle;
determining a rate of change of the moisture level of the occupant; and
adjusting a climate control system of the vehicle depending on the rate of change of the moisture level of the occupant.

2. The climate control method according to claim 1, the method comprising:
determining a temperature level of the occupant of the vehicle; and
comparing data based on the moisture level to data based on the temperature level to determine a physical condition of the occupant; and
adjusting the climate control system of the vehicle depending on the physical condition of the occupant.

3. The climate control method according to claim 2, the method comprising:
determining a temperature of an environment external to the vehicle;
comparing data based on the temperature of the environment external to the vehicle to data based on the moisture level of the occupant; and
adjusting the climate control system of the vehicle depending on a comparison between the data based on the temperature of the environment external to the vehicle and the data based on the moisture level of the occupant.

4. The climate control method according to claim 3, the method comprising:
determining a future geographical location of the vehicle;
determining the temperature of the environment external to the vehicle at the future geographical location; and
adjusting the climate control system of the vehicle depending on the temperature of the environment external to the vehicle at the future geographical location.

5. The climate control method according to claim 4, the method comprising:
determining a first moisture level of the occupant during a first journey;
determining a second moisture level of the occupant during a second journey;
creating an occupant profile based in the determined moisture levels; and
adjusting the climate control system of the vehicle depending on the occupant profile.

6. The climate control method according to claim 1, the method comprising determining remotely the moisture level of the occupant.

7. The climate control method according to claim 1, the method comprising determining the moisture level of skin of said occupant.

8. The climate control method according to claim 1, the method comprising:
determining a position of the occupant within the vehicle; and
automatically positioning one or more vents of the climate control system depending on the position of the occupant.

9. The climate control method according to claim 1, the method comprising:
determining a temperature of an environment external to the vehicle;
comparing data based on the temperature of the environment external to the vehicle to data based on the moisture level of the occupant; and
adjusting the climate control system of the vehicle depending on a comparison between the data based on the temperature of the environment external to the vehicle and the data based on the moisture level of the occupant.

10. The climate control method according to claim 1, the method comprising:
determining a future geographical location of the vehicle;
determining a temperature of the environment external to the vehicle at the future geographical location; and
adjusting the climate control system of the vehicle depending on the temperature of the environment external to the vehicle at the future geographical location.

11. The climate control method according to claim 1, the method comprising:
determining a first moisture level of the occupant during a first journey;
determining a second moisture level of the occupant during a second journey;
creating an occupant profile based in the determined moisture levels; and
adjusting the climate control system of the vehicle depending on the occupant profile.

12. A climate control system for a vehicle, the climate control system comprising:
a moisture sensor configured to determine a moisture level of an occupant of the vehicle; and
a controller configured to determine a rate of change of the moisture level of the occupant, and adjust the climate control system of the vehicle depending on the rate of change of the moisture level of the occupant.

13. The climate control system according to claim 12, wherein the moisture sensor is a non-contact sensor.

14. The climate control system according to claim 13 further including a temperature sensor configured to determine a first temperature of said occupant of said vehicle.

15. The climate control system according to claim 14, further including an external environment temperature sensor configured to determine a second temperature of an environment external to said vehicle.

16. A vehicle comprising the climate control system of claim 12.

17. A vehicle comprising the climate control system of claim 13.
